(19) United States
(12) Patent Application Publication
(10) Pub. No.: US 2005/0002102 A1
(43) Pub. Date: Jan. 6, 2005

(54) Illuminating system having a diffuser element

(75) Inventors: Ulrich Wegmann, Koenigsbronn (DE); Franz Trautwein, Aalen (DE)

Correspondence Address: SUGHRUE MION, PLLC, 2100 PENNSYLVANIA AVENUE, N.W., SUITE 800, WASHINGTON, DC, 20037, US

(73) Assignee: CARL ZEISS SMT AG

(21) Appl. No.: 10/835,470

(22) Filed: Apr. 30, 2004

(30) Foreign Application Priority Data
Apr. 30, 2003 (DE) 10320520.9

(51) Int. Cl. G02B 13/20; G02B 5/02

(52) U.S. Cl. 359/599

(57) ABSTRACT

An illuminating system having a diffuser element (2) that is introduced into an illuminating beam path (1) and is arranged movably, in particular for oscillatory movement. Such system has applicability, for example, in microlithography projection exposure machines and associated wavefront measurement interferometers.

The following disclosure is based on German Patent Application No. 103 20 520.9, filed on Apr. 30, 2003, which is incorporated into this application by reference.

### BACKGROUND OF THE INVENTION

1. Field of the Invention

The invention relates generally to an illuminating system. More particularly, the invention relates to an illuminating system having a diffuser element that is introduced into an illuminating beam path and arranged movably.

2. Description of the Related Art

Illuminating systems of this type are known in different designs. The mobility of the diffuser element normally serves in this case principally for reducing the spatial coherence of the illuminating radiation used. This is useful for various applications.

Thus, U.S. Pat. No. 6,061,133 discloses the use of a movable diffuser element in an interferometer, for example of the Fizeau type, Twyman-Green type or Mach-Zehnder type. The diffuser element is formed there from a circular diffuser plate or ground glass screen that is coupled to an electric motor in a fashion capable of rotation about an axis perpendicular to the plane of the screen. The motor is arranged with its axis of rotation parallel to the optical axis of the illuminating system in such a way that the ground glass screen is situated with a certain radial area within the illuminating beam path downstream of a laser light source or an illuminating lens downstream of the latter. If required, a second diffuser element, which remains immobile, can be positioned upstream of the movable ground glass screen. U.S. Pat. No. 4,869,593 also discloses such a use of a motor-driven rotating ground glass screen in the illuminating beam path of an interferometer for the purpose of optical surface inspection.

U.S. Pat. No. 5,614,989 describes a projection exposure machine for photographic image exposure comprising an illuminating system that has a ground glass screen mechanically coupled to a drive. Different variants are proposed for coupling the ground glass screen to the drive, such as coupling to a torque motor for rotating the ground glass screen, eccentric coupling to a torque motor for generating a two-dimensional oscillatory movement, or coupling to a loudspeaker coil for generating a one-dimensional oscillatory movement.

Diffuser elements are also used in illuminating systems of interferometers for the purpose of wavefront measurement of optical elements, such as for determining aberrations of high-resolution projection objectives in microlithography projection exposure machines for the purpose of exposing semiconductor wafers. The diffuser element, for example a ground glass screen, is intended in this case chiefly for homogenizing the pupil illumination, or for reducing or eliminating a parceling effect of a so called aerial illumination that is frequently used for mask illuminating microlithography projection exposure machines. Particularly in cases where the measuring interferometer is integrated in the projection exposure machine, which is also denoted as an operational interferometer, it is necessary for the restricted conditions of installation space to be borne in mind for the interferometer, and to pay attention that the actual illuminating function of the projection exposure machine is not disturbed by the components of the interferometer.

The illumination should be spatially sufficiently incoherent for such operational interferometers in order to achieve high measuring accuracy. Although an interferometer calibration in which the measured projection objective is rotated about the optical axis does come into consideration as a possible measure of achieving the required measuring accuracy, this requires an appropriate outlay, and cannot always be implemented structurally.

### OBJECTS OF THE INVENTION

One object on which the invention is based is to provide an illuminating system of the type mentioned above, which can be implemented and operated with a comparatively low outlay, requires little installation space and does not significantly disturb other system components possibly present in the surroundings, and which is therefore also particularly suitable for microlithography projection exposure machines and associated wavefront measurement interferometers.

### SUMMARY OF THE INVENTION

According to one formulation, the invention solves this and other objects by providing an illuminating system in which a diffuser element is arranged for oscillatory movement into an illuminating beam path. ‘Oscillatory movement’ is herein understood to mean that, in response to an appropriate oscillatory excitation, the element executes a non-driven oscillatory movement, that is to say an oscillation with a natural frequency, or a forced oscillation, which has no need of a permanent drive by an active drive means such as a motor or the like.

This implementation of the mobility of the diffuser element in the form of a non-permanently driven oscillatory movement has the advantage that corresponding permanently driving drive means can be eliminated, which reduces the need for installation space, and disturbances to other system components caused by such permanent drive means are avoided. In addition, the outlay on implementation and operation for such permanent drive means is eliminated, and friction forces that occur can be kept very small.

It is clear that, precisely also in the case of the use of the illuminating system for a shearing interferometer for the wavefront measurement of optically imaging systems, as well, such an oscillatory mobility of the diffuser element effects an incoherence of the illuminating radiation, usually originating from a highly coherent laser light source, that suffices for the required high measuring accuracy. This particularly avoids additional contributions of disturbing aberrations by insufficiently incoherent illumination when determining the aberrational defects of the projection objective of a microlithography projection exposure machine. Owing to the relatively low requirement for installation space, the diffuser element capable of oscillatory movement can readily be integrated in the projection exposure machine together with the remaining interferometer components, for example a wafer stepper or wafer scanner. Depending on what is required, the diffuser element capable of oscillatory movement can be used during interferometric measurement operation and/or during the normal wafer exposure operation.

The illuminating system according to the invention can also be used for any other illuminating purposes where there is a need to increase the measure of spatial incoherence for the illuminating radiation.

In one refinement of the invention, the diffuser element includes a diffuser plate that is held for oscillatory movement by a mechanical or an electrical/magnetic contactless support or suspension. Such an oscillating system is relatively simple to implement and permits an adequate capability of oscillatory movement for the diffuser plate.

In another refinement of the invention, gas pressure production means for directly or indirectly exciting oscillations for the diffuser element are provided, that is to say an oscillatory movement of the diffuser element is excited by a pressure wave or gas flow generated continuously or in a pulsed fashion by these means, and is maintained if required for a sufficient time period.

In a further refinement of this measure, the gas pressure production means are designed for producing a gas pressure wave or gas flow that sets oscillating the diffuser element itself and/or a holding element coupled thereto in a fashion capable of transmitting oscillations. The holding element can be, for example, a supporting foot or a holding arm that is coupled to the diffuser plate in a fashion capable of transmitting oscillations. For the purpose of directly exciting oscillation, the diffuser element can have a gas pressure resistance element to which the produced gas pressure can be applied.

In a further refinement of the invention, the gas pressure production means have an ellipsoidal gas pressure reflector and a gas pressure production unit arranged at one of its focal points. The other reflector focal point is situated in the range of oscillatory action of the diffuser element, that is to say the pressure wave or gas flow reflected by the reflector and collimated in the process excites the required oscillatory movement of the diffuser element.

In further refinements of the invention, impulse transmitting means or means for exciting oscillations operating electrostatically, magnetically and/or electrodynamically in a contactless fashion are provided for exciting oscillations, it being possible to use the various means for exciting oscillations individually or in combination, depending on requirement.

### BRIEF DESCRIPTION OF THE DRAWINGS

Advantageous embodiments of the invention are illustrated in the drawings, in which:

FIG. 1 shows a schematic side view of a part, of interest here, of an illuminating system for a microlithography projection exposure machine and/or for an associated shearing interferometer having a diffuser plate supported in an oscillating fashion,

FIG. 2 shows a schematic side view of a variant of the system of FIG. 1,

FIG. 3 shows a schematic side view of a system variant having a suspended, oscillating diffuser plate,

FIG. 4 shows a schematic side view of a system variant having a supporting foot that can be excited to oscillate,

FIG. 5 shows a schematic plan view of a diffuser plate, held in a torsionally flexible fashion, having a flow resistance element for directly exciting oscillations,

FIG. 6 shows a schematic side view of a system corresponding to FIG. 4, but with an additional gas pressure reflector,

FIG. 7 shows a schematic side view of a system variant having motorized excitation, fed by solar cells, of unbalanced oscillations of the diffuser plate,

FIG. 8 shows a plan view of the unbalanced motor and its solar cell feed for the system variant of FIG. 7,

FIG. 9 shows a schematic side view of a system variant with electromagnetic excitation, fed by solar cells, of oscillations of the diffuser plate,

FIG. 10 shows a schematic side view of a system variant having electrostatic excitation, fed by solar cells, of oscillations of the diffuser plate,

FIG. 11 shows a schematic side view of a system variant having means for exciting oscillations of the diffuser plate by hammer pendulum impulse impact, and

FIG. 12 shows a schematic side view of a system variant having means for exciting oscillations of the diffuser plate by impact excitation of a diffuser plate carrier.

### DETAILED DESCRIPTION OF THE PREFERRED EMBODIMENTS

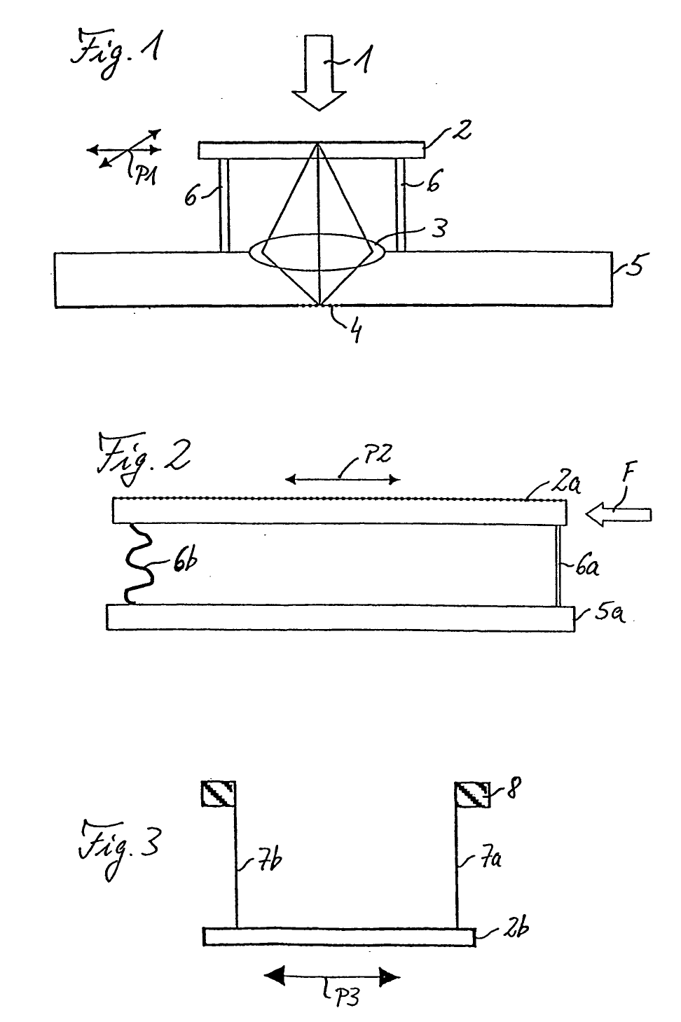

FIG. 1 shows a schematic of the part, presently of interest, of an illuminating system such as can be used in a microlithography projection exposure machine and in an associated interferometer for the purpose of wavefront measurement of a projection objective of the projection exposure machine. Positioned downstream of the illuminating system part shown is a laser light source (not shown) that emits, for example, UV light with a wavelength of 193 nm or some other wavelength.

The illuminating system part shown includes a diffuser plate 2 that is introduced into an illuminating beam path 1 of the system and is typically in the form of a ground glass screen downstream of which is a focusing optical system 3 that focuses the illuminating radiation passed by the diffuser plate 2 on to a mask structure 4. In the usual way, the mask structure 4 can be, for example, a chromium mask, and is mounted on the underside of a reticle 5 on the top side of which the focusing optical system 3 is held, and which reticle can be inserted into the illuminating beam path 1 in a way known per se by a movable reticle holder, that is to say a so called reticle stage and being moved out of said illuminating beam path. In the operating state, the chromium mask structure 4 usually lies in this case in the object plane of the downstream projection objective (not shown) of the projection exposure machine.

The diffuser plate 2 is held in an oscillating fashion on the reticle 5 by a support that comprises a number of supporting feet 6. The supporting feet 6 are formed by springs in such a way that the diffuser plate 2 is held substantially parallel to the plane of its plate for oscillatory movement above the reticle 5, as is symbolized by corresponding oscillatory movement arrows P1. For this purpose, the supporting springs 6 are implemented such that they can be deflected in a resiliently elastic fashion in the plane perpendicular to their longitudinal axis. It is possible in addition, or as an alternative, to provide that the supporting springs 6 can be deflected in a resiliently elastic fashion in the longitudinal direction, and this then leads to an oscillatory movement of the diffuser plate 2 also, or exclusively, parallel to the optical axis of the system.

In each of these cases, the diffuser plate 2 forms together with the supporting springs 6 an oscillating mass-spring system that can be excited to corresponding natural oscillations or forced oscillations. Depending on the grain structure of the diffuser plate 2 that is active in scattering light, oscillation amplitudes of the diffuser plate 2 of the order of magnitude of a few micrometers or a few tens thereof are sufficient for the desired coherence-destroying function, for example in the range from approximately 5 μm to approximately 20 μm. When use is made of a pulsed light source, the oscillating system of diffuser plate 2 and supporting springs 6 is designed such that consecutive light pulses strike different points of the diffuser plate 2. This design is readily possible through suitable tuning of the natural frequencies of this mass-spring system 2, 6.

The diffuser plate 2 on the one hand has the function of homogenizing the pupil illumination of the downstream projection objective, in which case, if use is made, for example, of an aerial illumination as illuminating radiation 1 the parceling thereof is reduced or eliminated. On the other hand, when it is set oscillating, by virtue of its oscillatory movement the diffuser plate 2 effects a reduction or elimination of the spatial coherence of the illuminating radiation 1 since, owing to the oscillatory movement, a respective illuminating component beam strikes different points of the diffuser plate 2, and a temporal variation of the beam path and the beam direction for the respective component beam are effected.

FIG. 2 shows a variant of the illuminating system of FIG. 1 in which a diffuser plate 2a is held for oscillatory movement in a transverse direction P2 at a reticle 5a without a focusing optical system at the reticle 5a. The oscillating support of the diffuser plate 2a at the top side of the reticle includes one or more supporting springs 6a of the type described above in relation to FIG. 1, and one or more bellows elements 6b. The oscillation of the diffuser plate 2a can be excited by lateral action with the aid of an impulsive force F. The impulsive force F is produced by a specifically provided means for exciting oscillations, or alternatively by appropriate impulsive movement of the reticle 5a via the associated reticle holder, by means of which the mass-spring system of diffuser plate 2a and supporting elements 6a, 6b is set in oscillation as a function of inertia. Depending on requirement, the action of the impulsive force F can be performed once or repeatedly, preferably at a frequency that corresponds to a natural frequency of the mass-spring system 2a, 6a, 6b. The latter can be implemented, for example, by moving the reticle 5a to and fro at such a natural frequency.

FIG. 3 shows an illuminating system variant that has as diffuser element a diffuser plate 2b suspended for oscillatory movement. Specifically, in this example the diffuser plate 2b is suspended as a pendulum system at two opposite lateral areas with the aid of a respective pendulum cord 7a, 7b from a frame part 8 of the projection exposure machine such that it pivots to and fro like a pendulum substantially in a transverse direction P3 in response to a corresponding excitation to oscillation.

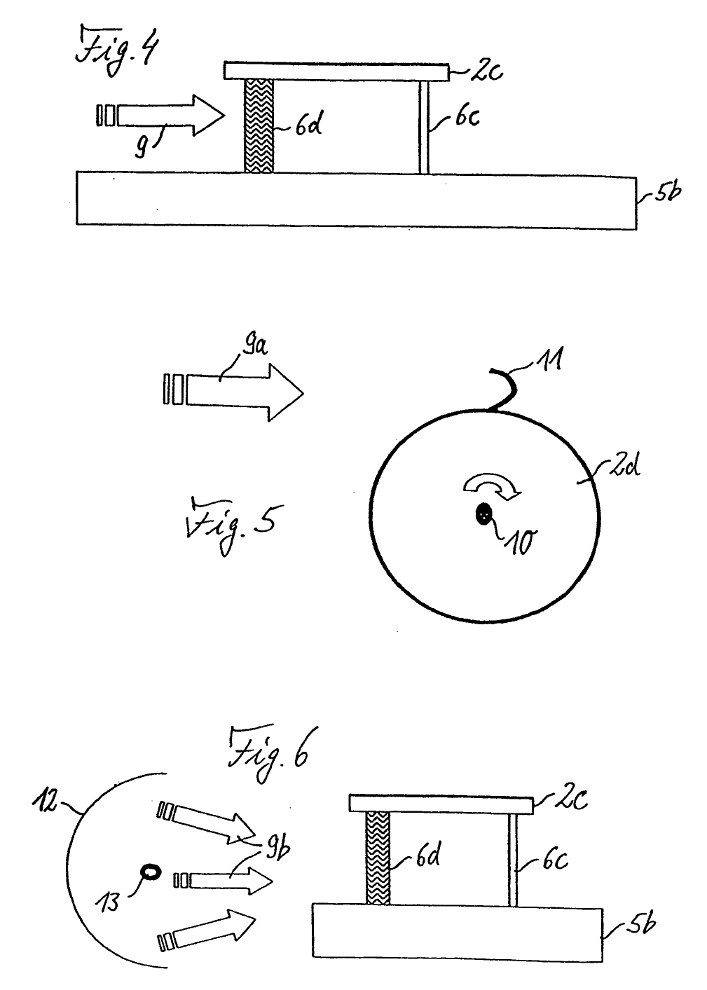

It is possible to use various means that excite oscillations in order to cause the diffuser element respectively used to execute its oscillatory movement, preferably at a natural frequency of the oscillating system. A few advantageous implementations of such means for exciting oscillation are explained below in more detail with reference to FIGS. 4 to 12, which illustrate corresponding illumination system variants.

A first group of means that can be used in order to excite the diffuser element to oscillations, preferably at a natural frequency, is based on gas pressure effects, in particular pressure wave or gas flow effects. Corresponding illuminating system variants are illustrated in FIGS. 4 to 6.

In a way similar to the examples of FIGS. 1 and 2, the variant shown in FIG. 4 includes a diffuser plate 2c supported for oscillatory movement on a reticle 5b by a number of supporting feet 6c, 6d, it being possible for at least one of the supporting feet to be set oscillating by a gas flow 9 guided past, in particular an air flow, on the basis of a pipe or tuning tongue effect. This can be implemented, for example, by designing the relevant supporting foot 6d as a leaf-spring tuning tongue. The oscillation of such type, excited by a continuous or pulsed gas flow 9, of the relevant supporting foot 6d is transmitted onto the diffuser plate 2c, which is coupled to said foot in a fashion capable of mechanically transmitting oscillations.

Overall, in this way the gas flow 9 excites the mass-spring system of diffuser plate 2c and resiliently elastic supporting feet 6c, 6d to an oscillatory movement with a natural frequency. Instead of the gas flow 9, which is supplied in a way known per se by a gas flow generation unit that is not shown, it is possible to use any other desired conventional gas pressure production means as means for exciting oscillations, for example sound waves of a sound wave generator. Several oscillation modes are preferentially excited depending on the design and arrangement of the supporting springs 6c, 6d, the excitation of a combined translatory and rotatory oscillation of the diffuser plate 2c being advantageous for most applications.

The illuminating system variant shown in FIG. 5 has a disk-shaped diffuser plate 2d that is held by means of a conventional torsion spring 10 (shown only schematically) such that it can move in a torsionally oscillatory fashion about an axis of rotation substantially parallel to the optical axis of the illuminating system. The diffuser disk 2d is provided at the periphery with at least one preferably curved, radial extension 11 that functions as a pressure wave or flow resistance element for a pressure wave or gas flow 9a directed thereto. In other words, depending on configuration, the extension 11 functions, for example, in a accordance with the principle of an aerofoil, windmill or sail. Consequently, applying the pressure wave or gas flow 9a to the extension 11 effects a torque on the diffuser disk 2d, which is thereby deflected against the restoring force of the torsion spring 10. This leads to a subsequent torsional oscillation movement of the diffuser disk 2d, it being possible for the associated pressure wave generator or gas flow generator to be switched off or operated in a pulsating fashion.

The illuminating system variant shown in FIG. 6 corresponds to that of FIG. 4 with the addition that there is provided for the purpose of raising the effectiveness an ellipsoidal pressure wave or gas flow reflector 12 at one of whose focal points an associated pressure wave or gas flow production unit 13 is arranged, while the leaf spring support 6d functioning as tuning tongue is placed in the region of the other focal point. The pressure wave 9b, for example sound wave, or gas flow, produced by the pressure wave/gas flow production unit 13 is focused by the reflector 12 onto the leaf spring tuning tongue 6d, which can thereby be set oscillating very effectively, for example by means of airborne sound in the form of a bang or a resonant excitation. One or more supporting springs of the diffuser plate 2c itself can be designed as pressure wave diaphragm, for example microphone diaphragm, for the purpose of further increasing the efficiency.

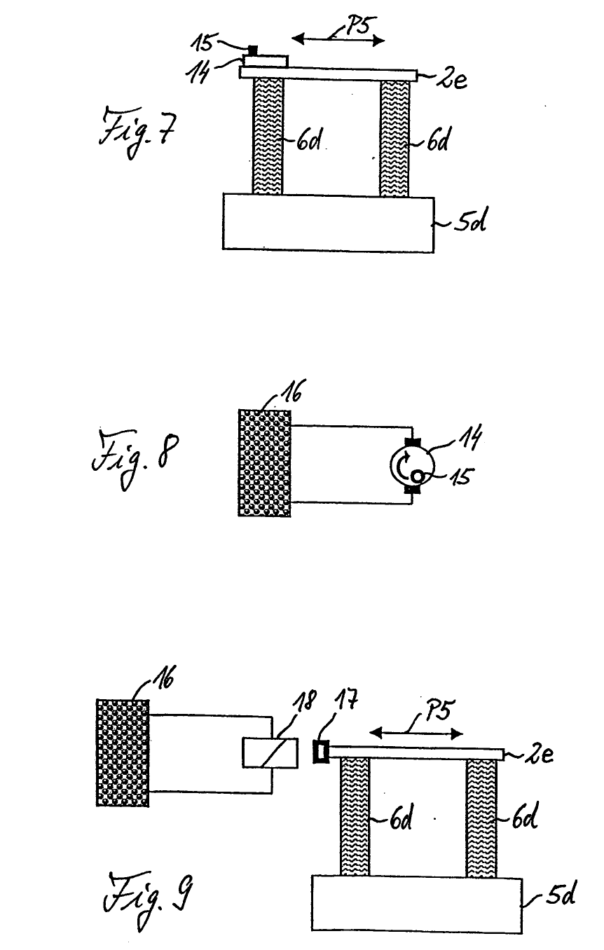

A second group of means for exciting oscillations that can be used is based on a likewise contactless excitation of oscillations by means of magnetic, electrostatic and/or electromagnetic forces. The energy required for the excitation of oscillations is preferably provided in these cases by the illuminating radiation itself or an additional auxiliary source in combination with a suitable energy-converting means for converting the radiant energy into the required, for example electric, energy. A solar cell, a diode, a selenium cell or an absorber layer, for example, is suitable as energy-converting means. Illuminating system variants of this second group are illustrated in FIGS. 7 to 10.

FIGS. 7 and 8 illustrate a variant that includes a diffuser plate 2e which is supported for oscillatory movement on a reticle 5d by means of a number of oscillating leaf spring supporting feet 6d and can be excited by motor to perform lateral oscillations P5. For this purpose, a miniature motor or micromotor 14 is mounted in a fashion capable of transmitting oscillations at a side region on the diffuser plate 2e. The motor 14 is provided with a rotary unbalance 15 as a result of which the motor 14 vibrates during operation. These vibrations are transmitted to the diffuser plate 2e, and as a result of this the diffuser plate 2e, that is to say, to be more precise, the oscillating system composed of diffuser plate 2e and leaf spring 6d, is excited to perform natural oscillations. As illustrated schematically in FIG. 8, a solar cell module 16 serves for feeding the motor 14.

The solar cell module 16 is preferably arranged such that its light-sensitive surface is struck by radiation that originates from the illuminating system itself and is not required for the exposure function of the projection exposure machine such as, for example, a component of scattered or reflected light, or irradiation component coupled out for this purpose, or an unused edge radiation component of an exposure beam incident on the diffuser plate 2e. For this purpose, the solar cell module 16 can likewise be arranged on an edge region of the diffuser plate 2e, or next to the diffuser plate 2e, or at another suitable point, preferably as an integral constituent of the illuminating system. An internal supply of energy to the motor 14 is then implemented thereby without an additional auxiliary energy source. Alternatively, in order to supply the solar cell module 16 with energy said module can be irradiated with an auxiliary light source arranged specifically therefor. In a further alternative embodiment, another conventional energy source, for example a battery, is provided instead of the solar cell module 16 for the motor 14. In further alternative variants, the motor 14 is not mounted overall on the diffuser plate 2e, but only a part of the motor that moves or vibrates during operation is mechanically coupled to the diffuser plate 2e in a fashion capable of transmitting oscillations, while the remaining motor constituents are placed separately from the diffuser plate 2e.

FIG. 9 shows a system variant similar to FIGS. 7 and 8, the same reference numerals being selected for mutually corresponding components, and it being possible to this extent to refer to the above explanations relating to FIGS. 7 and 8. The variant of FIG. 9 differs from those of FIGS. 7 and 8 in that an electromagnet arrangement is provided as means for exciting oscillations instead of the unbalanced motor 14. This electromagnet arrangement includes a magnet 17, preferably a permanent magnet, mounted on the diffuser plate 2e, and an electromagnet 18 situated laterally opposite said permanent magnet at a spacing. During operation, the electromagnet 18 is driven by means of an appropriate, conventional electronic circuit at a suitable alternating current frequency, preferably the natural frequency of the oscillating system composed of diffuser plate 2e and leaf springs 6d, as a result of which said system is excited to oscillations. Once again, the solar cell module 16 or an alternative energy source can serve for feeding energy to the electromagnet 18, as described above in relation to the exemplary embodiment of FIGS. 7 and 8.

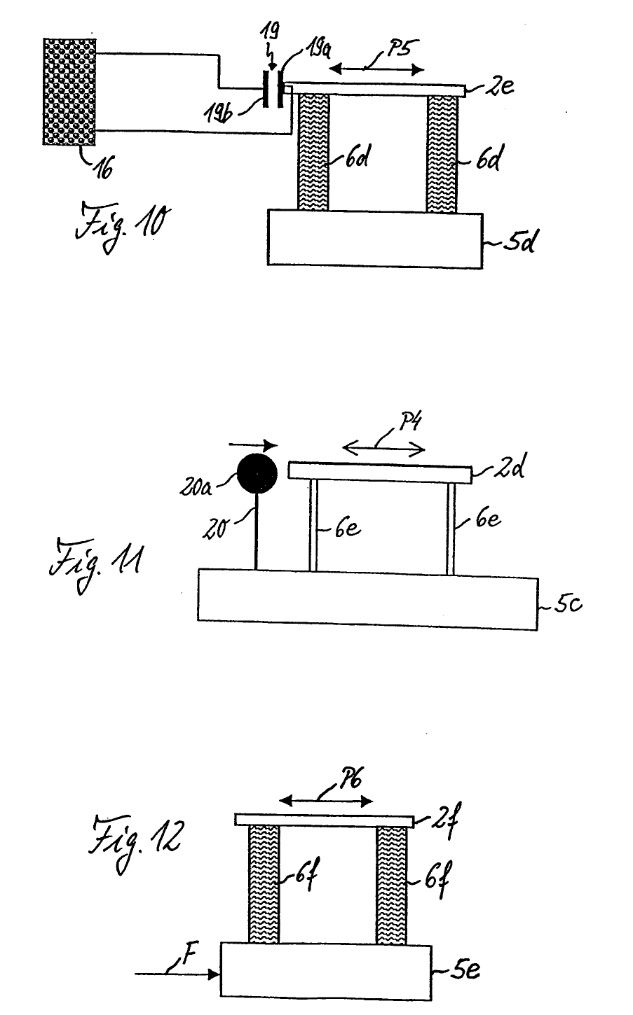

FIG. 10 shows a further modification of the system variants of FIGS. 7 to 9, which differs from these in that the means for exciting oscillations are of electrostatic design, specifically in the form of a plate capacitor 19. A plate electrode 19a is mounted laterally on the diffuser plate 2e, and the other plate electrode 19b is situated opposite it at a spacing outside the diffuser plate 2e. During operation, the plate capacitor 19 is driven by means of a suitable conventional electronic circuit (not shown in more detail) at an AC voltage frequency that preferably corresponds to the natural frequency of the oscillating system composed of diffuser plate 2e and leaf springs 6d. Once again, the solar cell module 16 or, alternatively, another electric energy source for the electronic circuit serves for supplying energy.

It may be noted at this point that electrodynamic, magnetic and/or electrostatic means such as were explained above as means for exciting oscillations in relation to the examples of FIGS. 7 to 10 can be used in a similar way to hold the diffuser element for oscillatory movement and preferably in a contactless fashion, for example via a reticle instead of the previously mentioned supporting foot holders.

A further group of means for exciting oscillations that can be used is based on a principle of mechanical impulse transmission. FIG. 11 shows a corresponding illuminating system variant. This includes, once again, a diffuser plate 2d held for transverse oscillatory movement by a reticle 5c by means of a number of spring supports 6e. In addition, aside from the diffuser plate 2d a hammer pendulum 20 whose hammer head 20a is at the level of the diffuser plate 2d is held on the reticle 5c. Deflecting and releasing the hammer pendulum 20 causes the hammer head 20a to strike laterally against the diffuser plate 2d, and in this way excites the mass/spring system of the diffuser plate 2d and spring supports 6e by mechanical impulse transmission to perform the desired oscillatory movement P4 at a natural frequency of the system. The deflection of the hammer pendulum 20 can be performed by any suitable conventional means, for example by motor, by a pressure wave or a gas flow or by electric or magnetic forces.

As already explained above briefly for the example of a reticle stage, there is a possibility, as an alternative or in addition to specifically provided means for exciting oscillations, of exciting the diffuser element to oscillate by means of an oscillating or impulse-like movement of the holder of the diffuser element, it being possible to control this movement of the holder which excites oscillations by means, for example, of a drive used for the holder, such as a reticle stage. This variant of the excitation of oscillations is advantageous, in particular, in connection with a pendulum suspension of the diffuser element. An implementation with impulse-type excitation of oscillations by means of the action of an impulse on a carrier of the diffuser element such as, for example, on a reticle, is shown in FIG. 12.

Specifically, in the variant of FIG. 12 a diffuser plate 2f is mounted via a number of leaf spring supports 6f on a laterally movable reticle 5e. The reticle 5e can be moved laterally impulsively by a laterally acting impulsive force F, as a result of which the oscillating system, mounted thereon, of diffuser plate 2f and leaf spring supports 6f is excited to perform natural oscillations that include a lateral oscillatory movement P6 of the diffuser plate 2f. Any desired conventional means can serve the purpose of producing the impulsive force F, for example ones which cause the reticle stage holding the reticle 5e to perform a jerky lateral step movement.

As becomes clear from the examples described above, the invention permits the provision of a very largely incoherent illuminating radiation in a relatively simple way by the use of a diffuser element held for oscillatory movement. In the course of use in a microlithography projection exposure machine during normal exposure operation and/or during a wavefront measurement of an associated projection objective for the purpose of highly precise determination of aberrations by means of a shearing interferometer, even in the case of the use of aerial illumination the parceling thereof can be sufficiently destroyed, and thus the pupil illumination of the objective can be homogenized and the strong spatial coherence of the laser radiation used can be rendered sufficiently incoherent.

The diffuser element is preferably capable of oscillating with more than one degree of freedom, for example in the form of two non-parallel degrees of translatory freedom or mixed degrees of translatory and rotatory freedom. The oscillating bearing of the diffuser element such as, for example a ground glass screen, can be performed, inter alia, with the use of leaf springs or spiral springs, by means of clamping at one end, in a multiple fashion, and/or using the tuning fork principle. The excitation of the oscillation can be performed, inter alia, by means of mechanical knocking, of electrical or magnetic deflection, or of pressure waves or a gas flow, for which purpose the diffuser element or components coupled to the latter have suitable incident-flow surfaces in order, for example, to implement an incident flow using the pipe principle. A high efficiency results in the event of tuning of the pipe frequency to the natural frequency of the oscillating system comprising the diffuser element. If required, a friction force compensation can be provided to maintain the oscillatory movement, for example by using electromagnetic forces in accordance with the principle of the mechano-electric wrist watch.

The invention can be applied not only for illuminating systems of microlithography projection exposure machines, but also for any other desired illuminating systems where there is a need to reduce the coherence of the illuminating radiation by using a diffuser element.

The above description of the preferred embodiments has been given by way of example. From the disclosure given, those skilled in the art will not only understand the present invention and its attendant advantages, but will also find apparent various changes and modifications to the structures and methods disclosed. It is sought, therefore, to cover all changes and modifications as fall within the spirit and scope of the invention, as defined by the appended claims, and equivalents thereof.

1. An illuminating system comprising:
a diffuser element that is introduced into an illuminating beam path and is arranged movably, wherein the diffuser element is arranged for oscillatory movement.

2. The illuminating system as claimed in claim 1, wherein the diffuser element comprises a diffuser plate that is held for oscillatory movement by at least one of a mechanical support, an electrical-magnetic contactless support, and a suspension.

3. The illuminating system as claimed in claim 1, further comprising a gas pressure production device exciting oscillations of the diffuser element.

4. The illuminating system as claimed in claim 3, wherein the gas pressure production device produces at least one of a gas pressure wave and a gas flow that produces the oscillatory movement of the diffuser element.

5. The illuminating system as claimed in claim 4, further comprising a holding element coupled to the diffuser element, wherein the gas pressure production device produces at least one of a gas pressure and a gas flow causing the holding element to oscillate, and wherein the oscillations of the holding element transmit to the diffuser element for the oscillatory movement.

6. The illuminating system as claimed in claim 5, wherein the holding element comprises at least one of a supporting foot and a holding arm for the diffuser element.

7. The illuminating system as claimed in claim 4, wherein the diffuser element comprises a gas pressure resistance element arranged to receive the produced gas pressure wave or gas flow.

8. The illuminating system as claimed in claim 3, wherein the gas pressure production device comprises an ellipsoidal gas pressure reflector and a gas pressure production unit arranged at one focal point of the gas pressure reflector, wherein a second focal point of the gas pressure reflector is situated in an oscillatory action range of the diffuser element.

9. The illuminating system as claimed claim 1, further comprising an impulse transmitting device exciting the oscillatory movement of the diffuser element by mechanical impulse impact.

10. The illuminating system as claimed in claim 1, further comprising at least one of an electrostatic device, a magnetic device and an electrodynamic device exciting oscillations of the diffuser element.

11. An illuminating system comprising:
a diffuser element positioned in a path of an illuminating beam, and
means for exciting oscillatory movement of the diffuser element in the illuminating beam path.
